(19) United States
(12) Patent Application Publication
(10) Pub. No.: US 2004/0160321 A1
(43) Pub. Date: Aug. 19, 2004

(54) Retro-fittable door monitoring switch system

(76) Inventor: Darrell Stephen Hoblack, Inglewood, CA (US)

Correspondence Address: Darrell Hoblack, 10514 Grevillea Ave., Inglewood, CA, 90304, US

(21) Appl. No.: 10/654,058

(22) Filed: Sep. 3, 2003

Related U.S. Application Data
(60) Provisional application No. 60/407,792, filed on Sep. 3, 2002.

(51) Int. Cl. G08B 13/08

(52) U.S. Cl. 340/547

(57) ABSTRACT

The self-storage industry requires a door monitoring system that can be retrofitted to existing facilities yet is easy to maintain and cost effective.

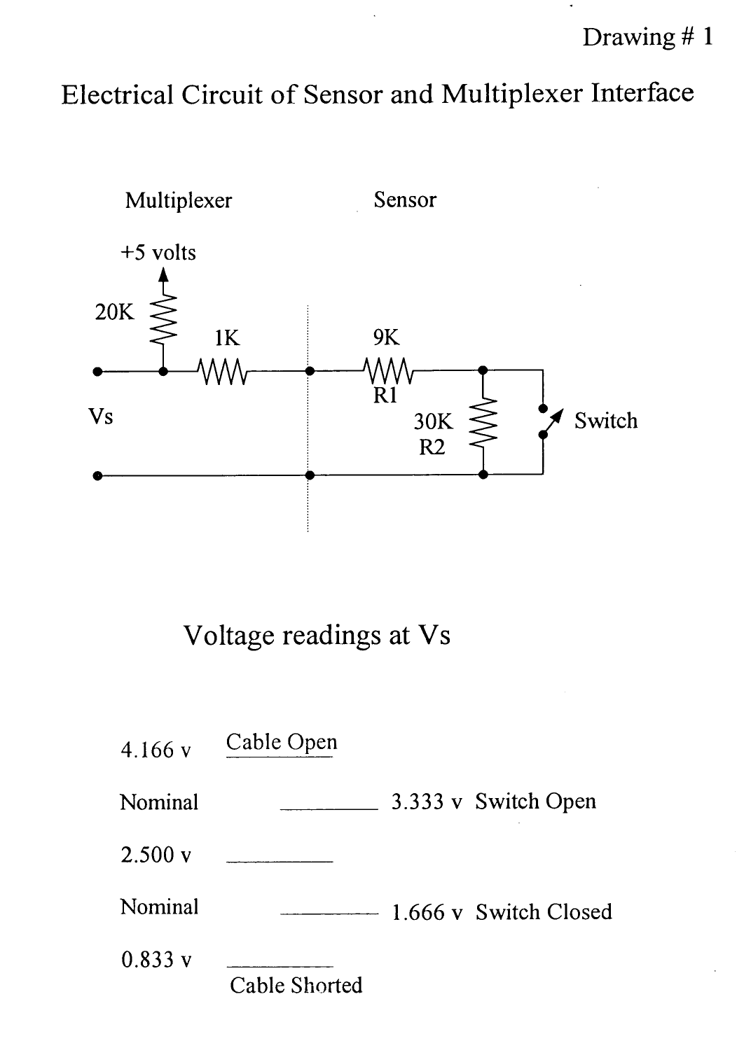

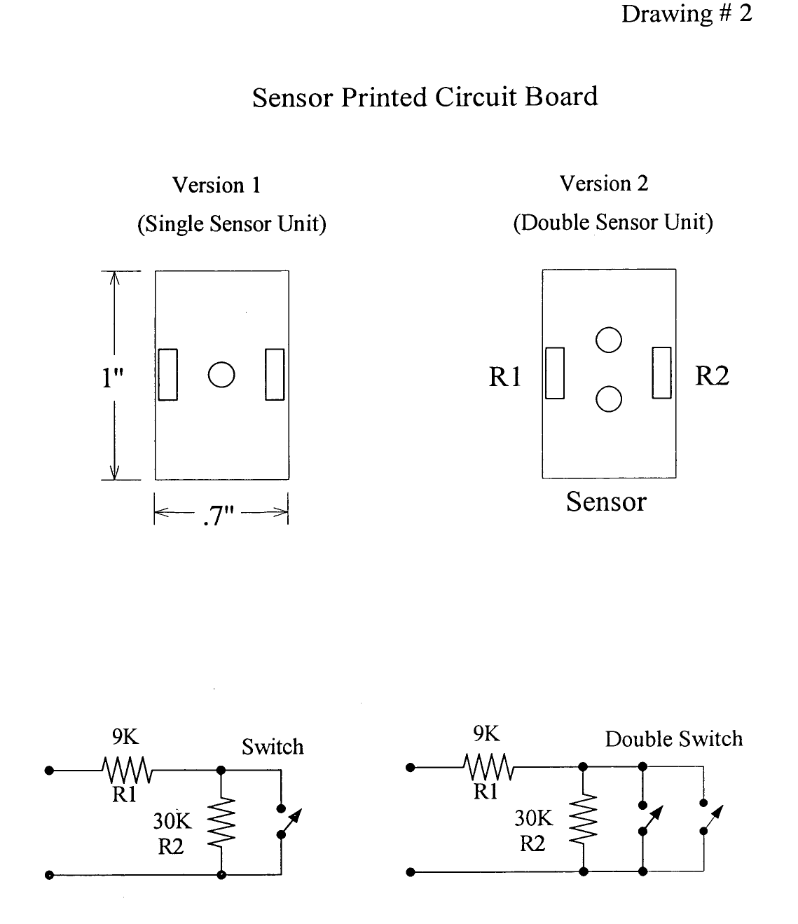

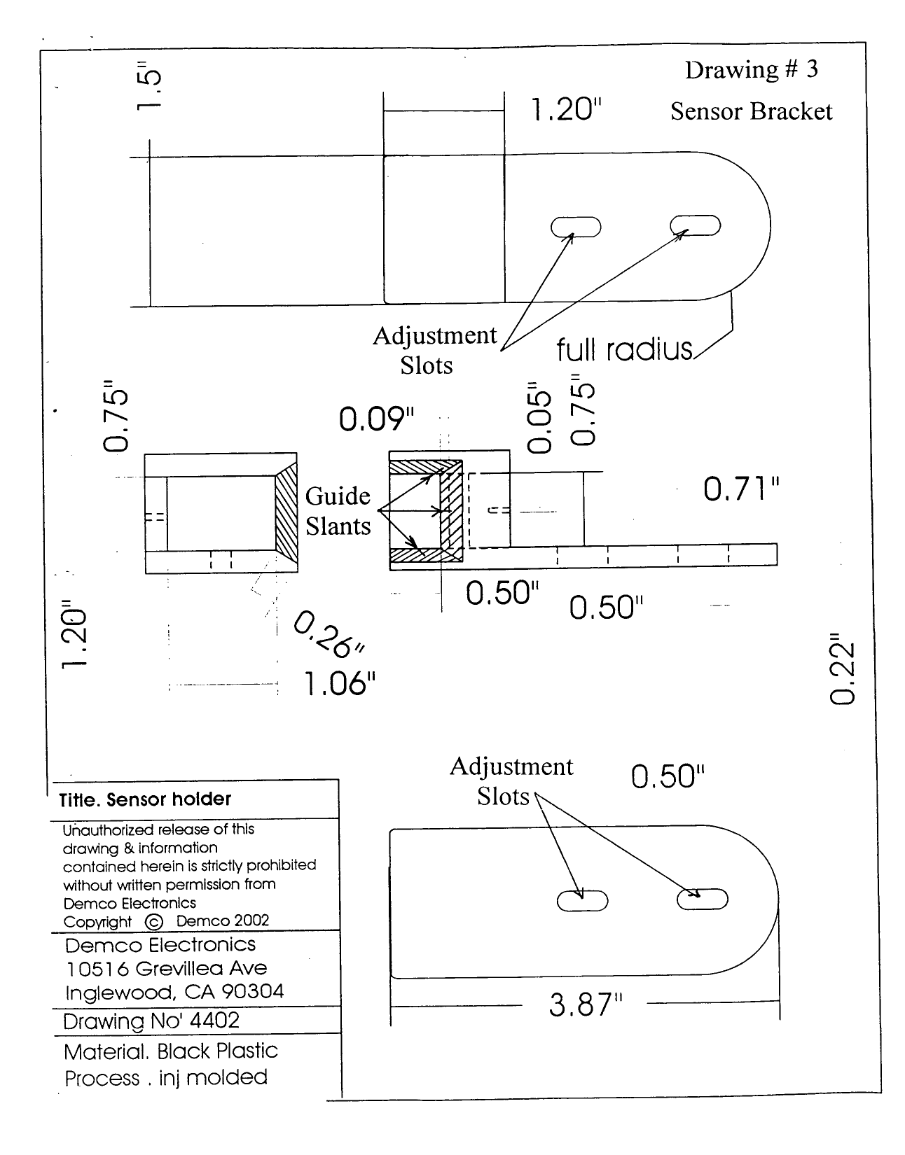

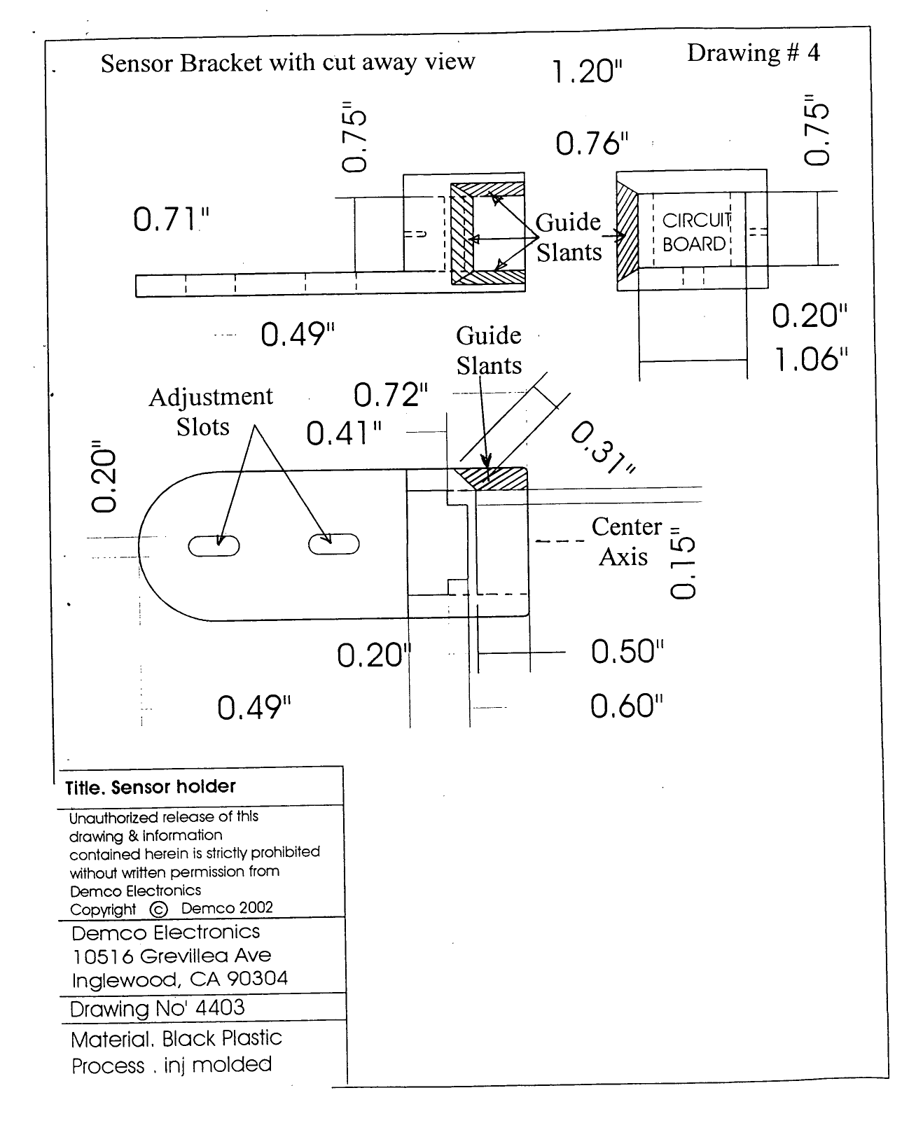

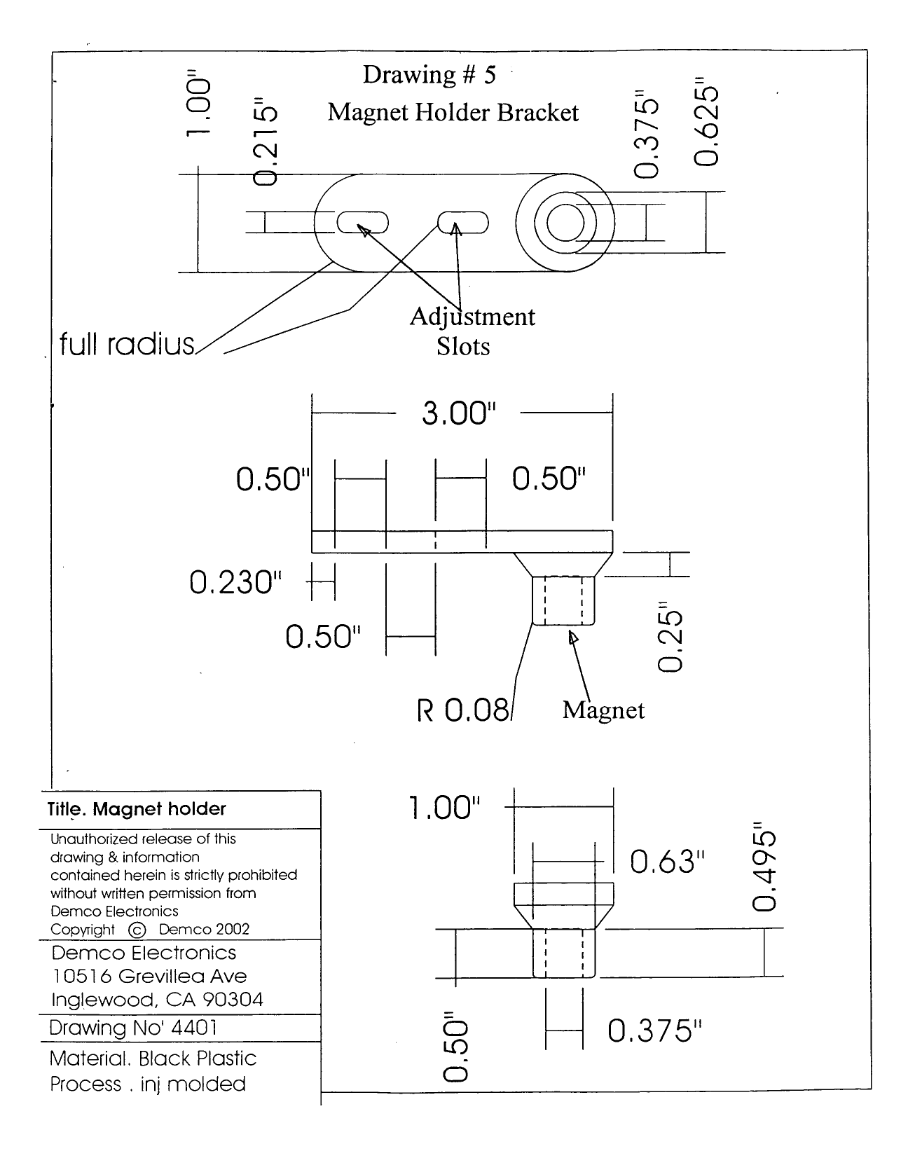

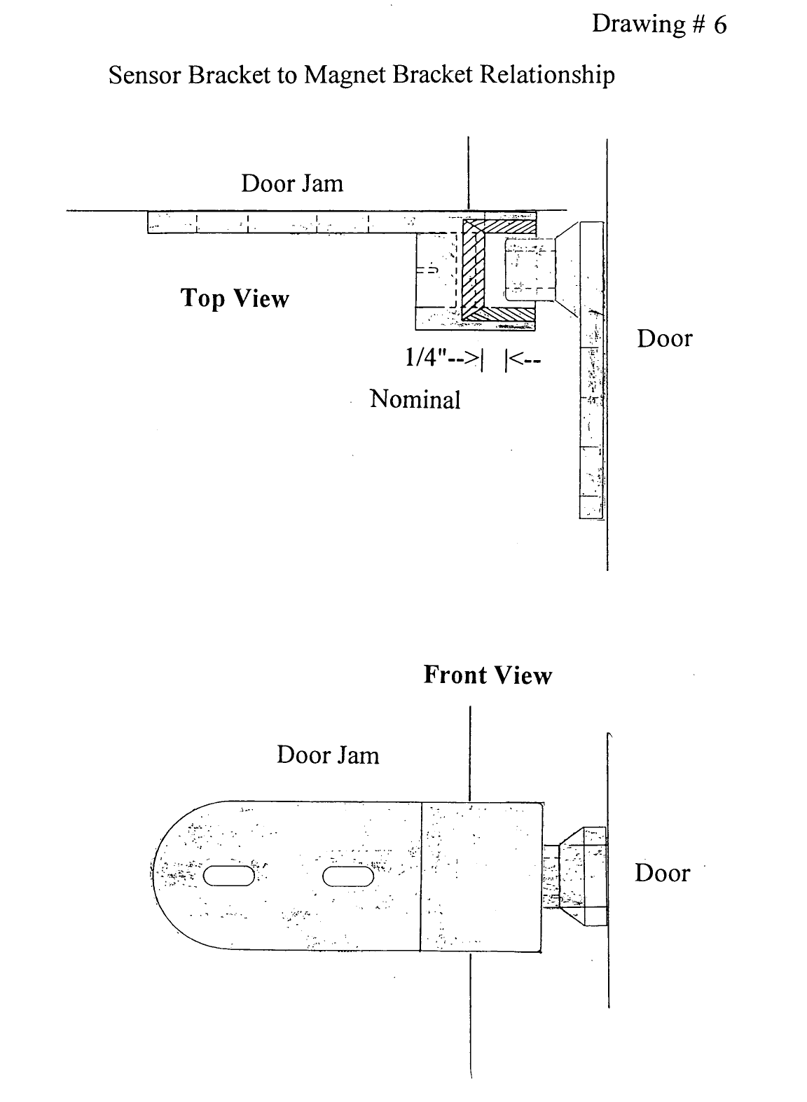

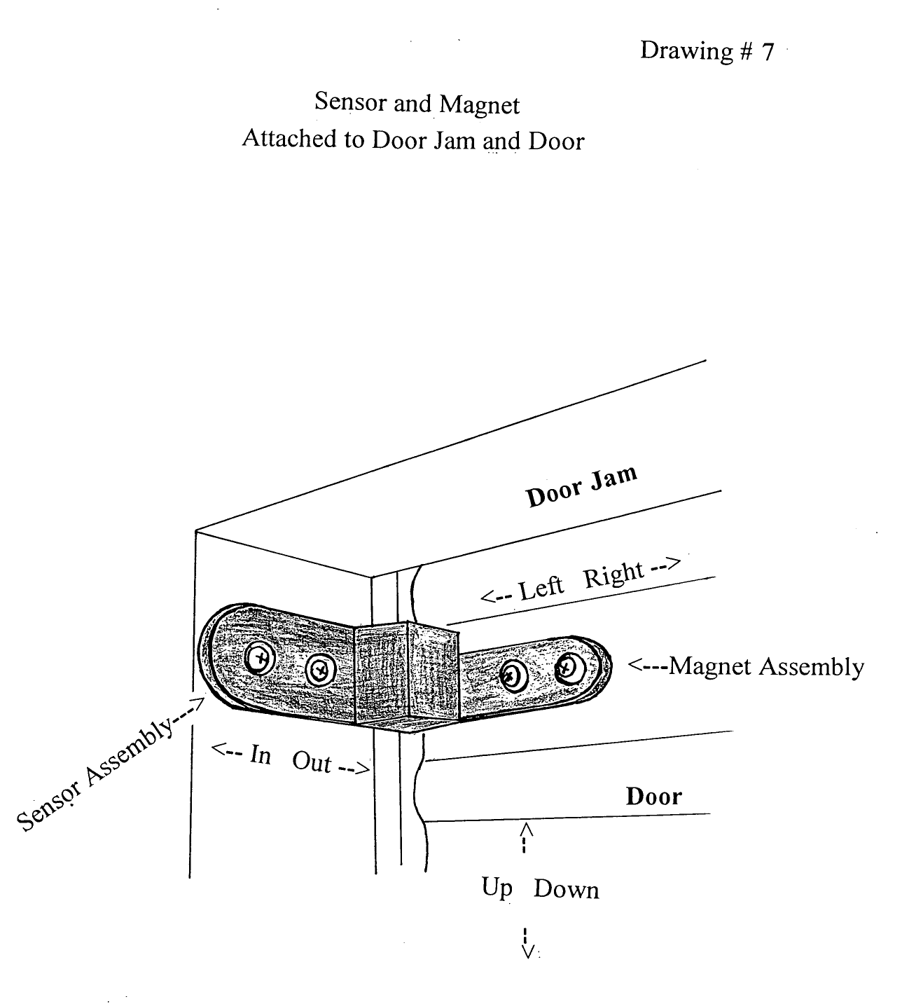

Combining a directional magnetic sensor with a wiring protecting scheme and packaging the combination in assemblies that are adjustable and self-adjustable results in a retro-fittable door monitoring system which is simple to install, easy to maintain, reliable and cost effective.

### CROSS-REFERENCES TO RELATED APPLICATIONS

Magnasphere Corp. P.O. Box 195, Brookfield, Wis. 53008. Magnetic Switch listed under U.S. and International patent Nos. 5,332,992, 5,530,428, 5,673,021, 5,880,659, 5,977,873, 6,087,963, & Patents Pending.

### FEDERALLY SPONSORED RESEARCH

None

### SEQUENCE LISTING

None

### BACKGROUND

Problem: A Self-Storage facility is a group of small cubicles with a door on each cubicle. A customer rents one or more of these cubicles called units, places their belongings in the unit, and installs their own lock to secure their unit. These units are usually in large buildings with long hallways or spread out on large lots with little supervision. One or more customers come into the manager's office and complain that some one was in their unit and some of their belongings have been stolen. The manager has no way of knowing if there was unauthorized entry into any of the units

Solution: Monitor each unit's door to determine when it is opened, and report to the manager if a door is open when it should not be open.

Problem: How do you determine which door should be opened.

Solution: Install an Access Control System, and monitor all the doors.

Problem: A renter of a particular unit enters a security code at the gate, which tells a Gate Access Control System that this legitimate tenant is on site. Now by monitoring which doors are open or closed, an alarm can be produced if a door is open that should not be opened.

Solution: Mount magnetic reed switch sensors and door magnets on the inside of the door of each unit and attach to sensing electronics which reports to an Access Control System to match unit doors open to legitimate tenants on site.

Problem: The Self-Storage business rents you a cubical with an entrance door, the customer provides their own lock and locks their unit. If the facility is an existing facility and you want to install a door monitoring system, you do not have access to the units to install the sensor and door magnets since the customer has locked their unit and only the customer has access to the unit. By not having access to the sensor and wiring, service people are also inhibited from servicing the sensor and wiring.

Solution: A Wireless Door Monitoring System where the sensors are mounted on the out side of the units and the wiring is replaced by radio signals.

Problem: The Wireless Door Monitoring Systems are more expensive than wired systems and require specially trained installers and repair personal. They also are very susceptible to the environment and to changes in the environment.

Solution: A Retro-fittable hard-wired Door Monitoring System. Mount the sensor on the outside of the unit doors like a wireless system, and connect the sensor to the electronics with wires like a hard-wired system.

Problem: Protecting the sensor and wiring from tampering.

Solution: Develop a system that can protect the wiring and sensor from tampering.

### Industries Approach

The sensor in a Wired Door Monitoring System is a reed switch enclosed in a plastic housing and mechanically mounted on the inside of the doorframe of each unit. Most unit doors in self-storage facilities are the roll-up style. A reed switch will close when a magnetic field is brought anywhere near the switch. By mounting a magnet on the inside of the unit's door in such a manner that when the door is closed (rolled down), the magnet is in proximity to the reed switch and the reed switch will close. The reed switch is connected to some electronics by two wires, and the electronics reports the status of the door (open or close) to the rest of the system. The sensor can be defeated by simply holding a second magnet in proximity to the reed switch while opening the door. Shorting the two wires going to the sensing electronics will simulate a closed door even if the door is opened. Since the sensor and wiring are sealed in a secured unit, neither the sensor nor the wiring can be tampered with or for that matter serviced.

This form of tamper resistance works well but has the problem of not easily being serviced, and next to impossible to be retrofitted to existing facilities.

Wireless system have over come the retrofitting problem by moving the sensor to the outside of the unit and replacing the wires with radio transmissions from the sensor to the receiving electronics. The sensor still has the same reed switch as the hardwired systems, but protects the switch from being tampered with by placing a second reed switch in a position to sense a second magnet being brought close to the sensor. This wireless approach has major drawbacks, namely cost, delayed reporting of problems, availability of trained installation and service personal, availability of test and trouble shooting procedures, and can be influenced by external factors such as weather and lightning.

### My Approach

I have approached the problem by moving the sensor to the outside of the units like the wireless system and connect the sensor to the electronics with wires like the hard-wired systems. The obvious problem is to protect the sensor and wiring from tampering.

### Protecting the Sensor from Magnetic Tampering

The approach I used is to incorporate a magnetic sensor into my system manufactured by Magnasphere Corp. P.O. Box 195, Brookfield, Wis. 53008. This magnetic switch is listed under U.S. and International patent Nos. 5,332,992, 5,530,428, 5,673,021, 5,880,659, 5,977,873, 6,087,963, & Patents pending (Reference Brochure). This switch has the property of closing only when it senses a magnetic field within a defined 60-degree conical zone radiating from the end of the switch (Axis). By mounting a magnet on the outside of the door, perpendicular to the door, and then mounting this sensor on an axis in line with the magnet, the sensor will close when the door is closed, and open when the door is open. Magnets brought in from the side will not close the switch having the system report a closed door even if it is open.

The door switch detector will sense a closed door only when the magnet attached to the unit door is brought into proper alignment with the sensor. When the door is closed, any other strong magnetic field brought into proximity of the sensor will either not effect the switch or will cause the door switch to sense an open door. The door open will be noticed by the multiplexer, and than communicated to the controller, which will report an alarm condition.

### Protecting the Wiring from Tampering

Protecting the wiring from being shorted or opened is accomplished by incorporating a few resistors into the sensor (Reference Drawing 1). The resistors are in a voltage divider network and have been selected to produce the following voltages at Vs with the input voltage at +5 volts DC:

1. If the switch is open, the voltage will be nominally 3.33 volts.

2. If the switch is closed, the voltage will be nominally 1.66 volts.

3. If the cable is open, the voltage will be approximately 5 volts.

4. If the cable is shorted, the voltage will be approximately 0 volts.

By monitoring this voltage, I can determine it the cable is open or shorted, and if the cable is not open or shorted, if the switch is open or closed. All Cable and Sensor conditions will be reported instantly.

By using this new type of magnetic sensor and resistor network arrangement, I have protected the sensor and cabling from tempering.

Two problems arise with using this new magnetic switch. First of all the new magnetic sensor will only sense a strong magnetic field from a distance of 1/2 inches or less (referred to as the air gap distance). Most conventional hard-wired systems have an air gap as large as 3″. This large air gap is needed to make up for the slop in the installations of the sensors due to the fact that solid brackets have not been provided by the door manufacturer. Secondly, the sensor will close if a piece of ferrous material is within about 1/8 inch of the axis of the sensor. These problems are resolved by the mechanics of the brackets for the sensor and magnet.

I have selected a 3/8″ diameter by 1/2″ long Neodymium Iron Boron magnet as the magnet to be used in this design because of its small size and extremely strong magnetic field. Increasing the magnetic field increases the air gap there by decreasing the possibility of not sensing the magnet if the door is not in perfect alignment. The magnet is designed to be at a nominal distance of 1/4″ from the magnetic sensor and in line with its axis. I can keep this nominal distance by having slanted guides on the top of the sensor bracket to guide the magnet into position with the sensor. The mounting holes in both the magnet and sensor brackets are slotted to allow for proper alignment during installation. The sensor is also protected from having a piece of ferrous material from being inserted from the bottom or sides by the sensor bracket it's self. The gap between the sensor and magnet is protected from any ferrous material from being inserted by the bracket's rap around construction. Only the magnet itself can be inserted from above, as the door is lowered shout.

The slotted mounting holes in the magnetic assembly allow for adjusting the magnet to align with the sensor in the horizontal direction (Reference Drawing #5). The slotted mounting holes in the sensor assembly allow for adjusting the magnet to align with the sensor in the front to back direction (Reference Drawing #3). These adjustments are made in the initial installation or adjustments if the door and jam move from their original alignment (Reference Drawing #7). The slants in the sensor assembly guide the magnet assembly into position if the alignment is slightly ajar (Reference Drawing #3). The only direction of misalignment that has not been accounted for is for up and down movement of the door to the jam. To allow for slop in the door to jam relationship in the up and down direction, I have placed two magnetic sensors in the sensor assembly. The two sensors are placed plus and minus 0.2″ from the center of the sensor printed circuit board in the up/down direction. By placing the two sensors 0.4″ from each other allows for about 0.8″ slop, from the center of the printed circuit board, in misalignment of the sensor to the magnet in the up and down direction.

This bracket assembly is designed for installation of roll up doors, but can be fitted to any door with slight modifications to the brackets.

### SUMMARY

Door alarm systems have historically been based on having magnetic sensors placed on the inside of each unit's door.

These systems have been very successful, but have the inherent problem of not being retro-fittable on existing facilities and not easily serviceable after initial installation since the sensor and cabling are sealed inside the customer's locked units.

To over come these problems, wireless systems have become popular since the sensors are located outside the units. Wireless systems, have there own inherent problems of being more expensive, more problematic, influenced by weather and requiring specially trained installation and service personnel.

I have developed a new approach to the problem. By designing a new sensor/multiplexer combination which delivers all of the advantages of both wired and wireless systems with none of their disadvantages. Moving the sensor and magnet to the outside of the unit, resolves the installation and repair problems associated with a standard hard-wired system. By protecting the sensor and cabling from being tampered with, allows the system to be retro-fitted like the wireless systems.

My new sensor/multiplexer will trigger an alarm condition if an external magnet is brought near the sensor or the cable is shorted or opened.

Incorporating these two features results in a door monitoring system that can be mounted external to the units, allows for retro-fitting of door monitoring systems on existing facilities, and also enables the installer to use the installation and diagnostic procedures of the older hard wired systems.

I have brought together the best of both standard hard wired and wireless systems to produce the next generation of door monitoring systems for both new construction and existing facilities.

### DRAWINGS

Brochure front/rear of Magnasphere magnetic sensor

Drawing 1—Electrical Circuit of Sensor and Multiplexer Interface

Drawing 2—Sensor Printed Circuit Board drawing with circuit

Drawing 3—Sensor Bracket drawing

Drawing 4—Sensor Bracket drawing (cutaway view)

Drawing 5—Magnet Holder Bracket

Drawing 6—Sensor Bracket to Magnet Bracket Relationship drawing

Drawing 7—Sensor and Magnet Attached to Door Jam and Door

### DETAILED DESCRIPTION

The front and rear of Magnasphere's magnetic sensor brochure showing the detailed description of their sensor and in particular the feature of interest in my design is the 60-degree activation angle.

Drawing 1 shows the electrical drawing of the Multiplexer and Sensor interface. This drawing also shows the nominal voltages for the four conditions that need to be sensed Open Cable, Open Switch, Closed Switch, and Shorted Cable.

Drawing 2 shows the mechanical dimensions and layout of the sensor printed circuit boards. The drawing also shows the electrical drawing for a single and double sensor.

Drawing 3 shows the mechanical dimensions of the Sensor Assembly. Important features of the assembly are the guide slants on top of the assembly and the slotted alignment holes.

Drawing 4 shows the mechanical dimensions of the Sensor Assembly with a cutout of the cavity for the sensor electronics.

Drawing 5 shows the mechanical dimensions of the Magnet Holder Bracket.

Drawing 6 shows the mechanical dimensions of the Sensor Assembly and Magnet Assembly.

Drawing 7 shows the relationships of the Sensor to the doorframe, Magnet Assemblies to the door and of the Sensor Assembly to the Magnet Assembly when the door is closed.

### REFERENCE NUMERALS

### OPERATION

Drawing #7 shows a typical roll up door mounted to a doorframe. The Magnet assembly is mounted to the top left side of the door in a left-right orientation as shown. The Sensor assembly is mounted to the top left side of the door jam in an In-Out orientation. The magnet assembly is adjusted by loosening the two mounting screws, and moving the assembly left or right to center the magnet in the slot of the sensor assembly. The sensor assembly is adjusted by loosening the two mounting screws holding the assembly to the frame of the door. With the door closed and at rest, move the sensor assembly in or out to locate the back of the sensor cavity to about 1/4″ from the end of the magnet. After making these adjustments, the sensor and associated electronics will sense an open door when the door is lifted up, and will sense a closed door when the door is in the fully closed position.

1. I claim that the system explained above will give Self-Storage owners a cost effective, retro-fittable, easily installable and maintainable Door Monitoring System in their facility.
